(19) United States
(12) Patent Application Publication
(10) Pub. No.: US 2015/0008996 A1
(43) Pub. Date: Jan. 8, 2015

(54) Surface Wave Launcher

(71) Applicant: Roke Manor Research Limited, Romsey (GB)

(72) Inventors: Michael Jessup, Romsey (GB); Janice Turner, Romsey (GB)

(21) Appl. No.: 14/321,961

(22) Filed: Jul. 2, 2014

(30) Foreign Application Priority Data
Jul. 2, 2013 (GB) 1311870.8

(51) Int. Cl. H01P 3/02

(52) U.S. Cl. CPC H01P 3/026
USPC 333/240

(57) ABSTRACT

A surface wave launcher for launching electromagnetic surface waves, the launcher comprising: a waveguide having a feed end and a launch end; a feed structure coupled to the feed end of the waveguide; wherein the feed structure includes a first conductor; the waveguide comprises a first planar conductive layer having a feed end and a launch end, the feed end being coupled to the first conductor; and the waveguide is arranged to be positioned adjacent a surface suitable for guiding electromagnetic surface waves, wherein the width of the first planar conductive layer tapers from the launch end towards the feed end.

The present invention relates to a surface wave launcher.

### BACKGROUND

The applicant's prior published patent application GB2,494,435A discloses a communication system which utilises a guiding medium which is suitable for sustaining electromagnetic surface waves. The contents of GB2,494,435A are hereby incorporated by reference. The present application presents various applications and improvements to the system disclosed in GB2,494,435A.

### BRIEF SUMMARY

In a first aspect, the present invention provides a surface wave launcher for launching electromagnetic surface waves, the launcher comprising: a waveguide having a feed end and a launch end; a feed structure coupled to the feed end of the waveguide; wherein the feed structure includes a first conductor; the waveguide comprises a first planar conductive layer having a feed end and a launch end, the feed end being coupled to the first conductor; and the waveguide is arranged to be positioned adjacent a surface suitable for guiding electromagnetic surface waves, wherein the width of the first planar conductive layer tapers from the launch end towards the feed end.

In a second aspect, the present invention provides a surface wave launcher for launching electromagnetic surface waves, the launcher comprising: a waveguide having a feed end and a launch end; a feed structure coupled to the feed end of the waveguide; wherein the feed structure has a primary axis and includes a first conductor; the waveguide comprises a first planar conductive layer coupled to the first conductor and extending radially outward relative to the primary axis; the waveguide is arranged to be positioned adjacent a surface suitable for guiding electromagnetic surface waves; and the waveguide comprises one or more elements arranged to cause a signal generated by the waveguide to be emitted in a predetermined direction.

Further examples of features of the present invention are recited in the claims.

### DESCRIPTION OF THE DRAWINGS

Embodiments of the present invention will now be described, by way of example only, and with reference to the accompanying drawings, in which:

FIG. 1 shows a surface wave launcher in accordance with a first embodiment of the present invention;

FIG. 2 shows cut-away view of the surface wave launcher shown in FIG. 1;

FIG. 3 shows a surface wave launcher in accordance with a second embodiment of the present invention;

FIG. 4 shows cut-away view of the surface wave launcher shown in FIG. 3;

FIG. 5 shows a surface wave launcher in accordance with a third embodiment of the present invention;

FIG. 6 shows cut-away view of the surface wave launcher shown in FIG. 5;

FIG. 7 shows cut-away view of a surface wave launcher in accordance with a fourth embodiment of the present invention; and

FIG. 8 shows cut-away view of a surface wave launcher in accordance with a fifth embodiment of the present invention.

### DETAILED DESCRIPTION

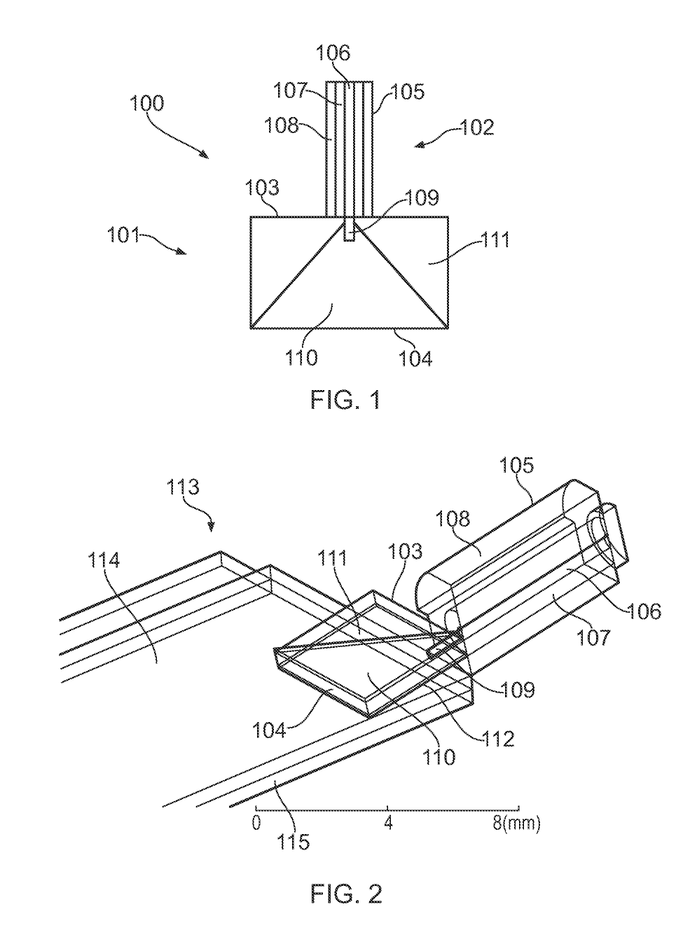

FIG. 1 shows a surface wave launcher 100 in accordance with a first embodiment of the present invention. The surface wave launcher includes a parallel-plate waveguide 101 and a feed section 102. The waveguide 101 includes a feed end 103 and a launch end 104. The feed section 102 is coupled to the waveguide 101 as the feed end 103. The feed section includes a coaxial cable 105. The coaxial cable includes an inner conductor 106, an insulating layer 107 and an outer conductor 108. The feed section 102 also includes a coupling pin 109 which is connected to the inner conductor 106 at an end of the coaxial cable.

The waveguide 101 is a rectangular cuboid. The waveguide 101 includes a first planar conductor 110, which is forms an upper surface of the waveguide. The first planar conductor 110 forms an isosceles triangle, the top vertex of which is connected to the coupling pin 109. In this sense, the width of the first planar conductor 110 tapers from the launch end of the waveguide 101 to the feed end. The waveguide 101 also includes a dielectric layer 111, positioned below the first planar conductor 110, and which is also a rectangular cuboid. The dielectric 111 is preferably low loss for the frequency of operation. The waveguide 101 also includes a second planar conductor (not shown in FIG. 1), which is positioned behind the dielectric layer 111. The second planar conductor is rectangular in shape, and completely covers the underside of the dielectric 111.

FIG. 2 shows a cross-section through launcher 100. The features of the launcher 100 are labelled in the same manner as in FIG. 1. In FIG. 2, the second planar conductor 112 is shown. The outer conductor 108 of the coaxial cable 105 is coupled to the second planar conductor 112.

FIG. 2 also shows a guiding medium 113 with which the surface wave launcher 100 is arranged to operate. The guiding medium may be similar to that described in the applicant's previously published UK patent application GB2,494,435. The guiding medium 113 includes a dielectric layer 114 and a conductive layer 115. Together they form a dielectric coated conductor with a reactive impedance which is higher than the resistive impedance. Such a surface is suitable for the propagation of electromagnetic surface waves. In use, the launcher 100 can be placed at a shallow angle to the surface of a guiding medium 113 to launch waves in a particular direction. The performance of the launcher 100 at a particular frequency can be optimised by changing the length of the triangle.

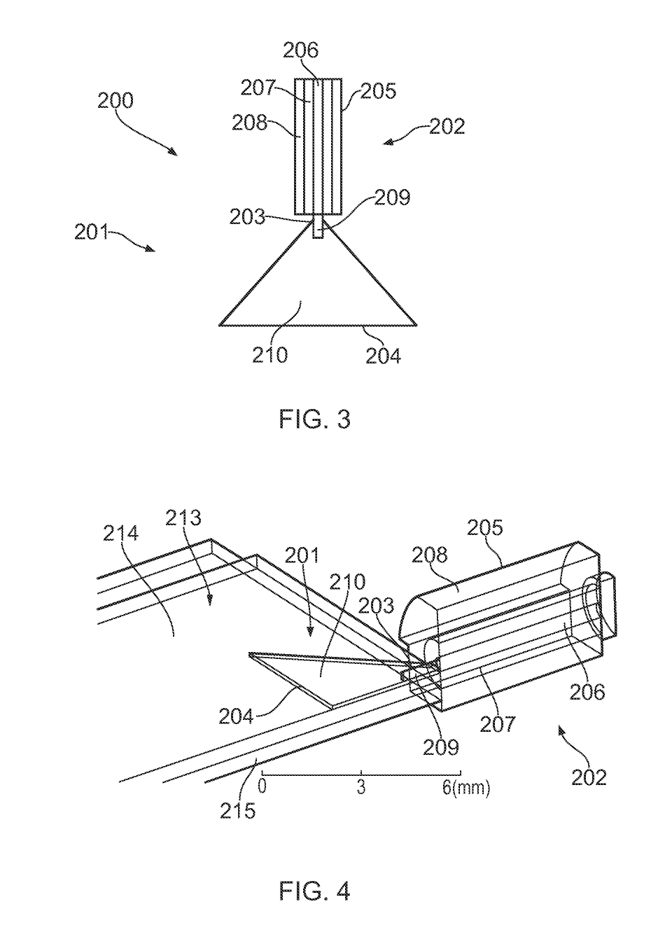

FIG. 3 shows a surface wave launcher 200 in accordance with a second embodiment of the present invention. The surface wave launcher includes a waveguide 201 and a feed section 202. The launcher 200 is identical to launcher 100, except that the waveguide 201 does not include a dielectric layer or a second planar conductor. The waveguide 201 includes a feed end 203 and a launch end 204. The feed section 202 is coupled to the waveguide 201 as the feed end 203. The feed section includes a coaxial cable 205. The coaxial cable includes an inner conductor 206, an insulating layer 207 and an outer conductor 208. The feed section 202 also includes a coupling pin 209 which is connected to the inner conductor 206 at an end of the coaxial cable.

The waveguide 201 includes a first planar conductor 210. The first planar conductor 210 forms an isosceles triangle, the top vertex of which is connected to the coupling pin 209. As in FIG. 1, the width of the first planar conductor 210 tapers from the launch end of the waveguide 201 to the feed end.

FIG. 4 shows a cut-away through launcher 200. FIG. 4 also shows a guiding medium 213 with which the surface wave launcher 200 is arranged operate. The guiding medium may be similar to that described in connection with FIG. 2. In particular, it includes a dielectric layer 214 and a conductive layer 215.

In use, the triangular conductor 210 is positioned on top of the dielectric 214 of the guiding medium 213. The first planar conductor 210 arranged in parallel and in contact with the top surface of the guiding medium 213. The outer conductor 208 of the coaxial cable 205 contacts the conductive layer 215 at the bottom of the guiding medium 213. In this manner, the launcher 200 acts as a parallel-plate waveguide by using the conductive layer 215 of the guiding medium 213 as a second plate.

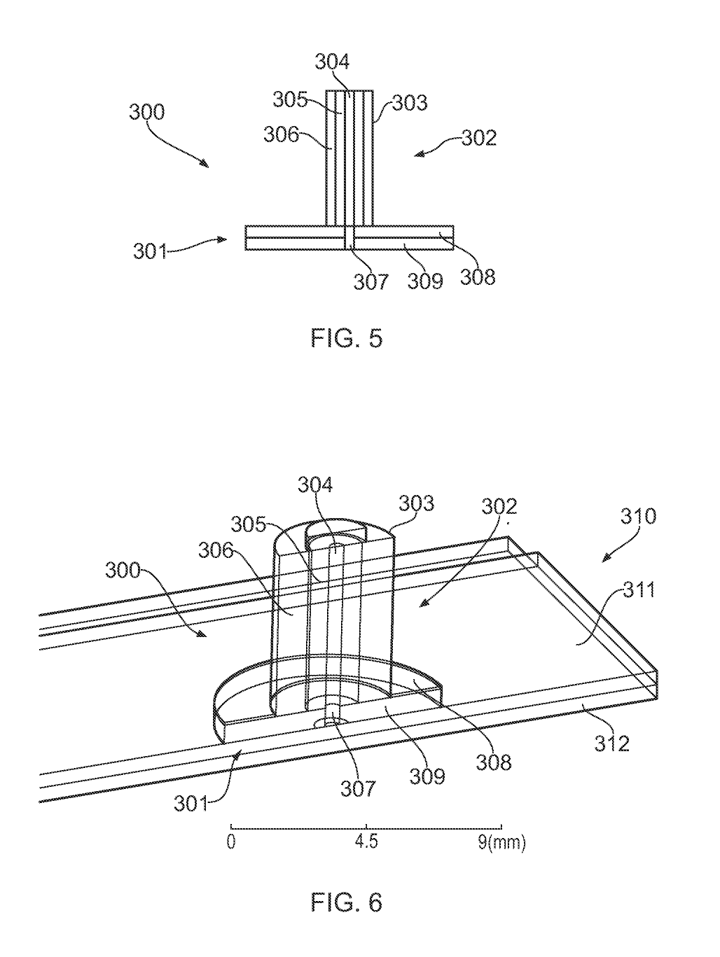

FIG. 5 shows a cross-section through a launcher 300 in accordance with a third embodiment of the present invention. The launcher 300 includes a radial waveguide 301 and a feed section 302. The feed section 302 includes a coaxial cable 303. The coaxial cable 303 includes an inner conductor 304, an insulating layer 305 and an outer conductor 306. The feed section 302 also includes a coupling pin 307, for coupling the inner conductor 304 to the waveguide 301. The waveguide 301 extends radially outward from the feed section. The waveguide 301 may comprise a disc of conductor 308 positioned on top of a disc of dielectric 309. The coupling pin 307 of the coaxial cable 303 passes through the centre of the dielectric disc 309. The launcher 300 can be used to launch surface waves along a guiding medium. The performance of the launcher at a particular frequency can be optimised by changing the radius of the conducting and dielectric discs, length of the pin and by adding a further disc of conductor to the bottom of the dielectric contacting the end of the pin.

FIG. 6 shows a cut-away through launcher 300. The features of the launcher are identified with the same reference numerals. FIG. 6 also shows a guiding medium 310 which includes a dielectric layer 311 and a conductive layer 312. The launcher 300 acts as an omnidirectional surface wave launcher. By placing the waveguide 301 in parallel to and adjacent to the dielectric layer 311 of the guiding medium 310, surface waves may be made to propagate in all directions.

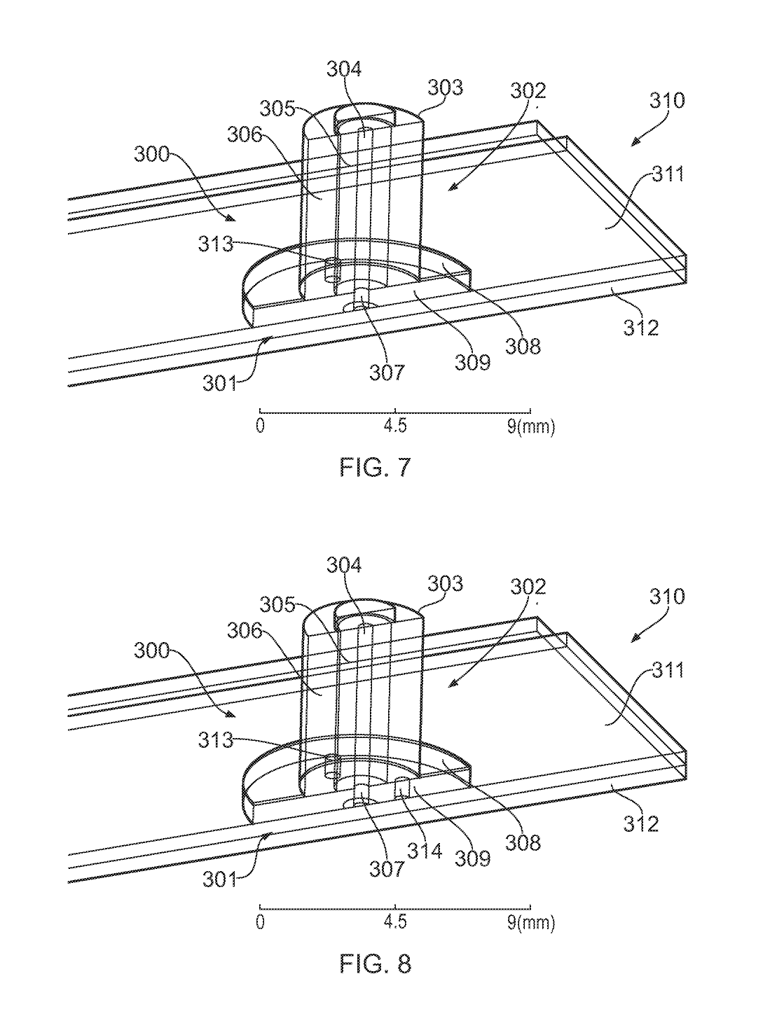

The launcher design shown in FIG. 7 is identical to that shown in FIGS. 5 and 6 with the exception of two axially orientated conducting pins 313, added approximately a half wavelength either side of the centre pin. These added pins act as reflectors making the launcher bi-directional.

The launcher design shown in FIG. 8 is identical to that shown in FIG. 7 with the exception of one pin 314 added approximately a quarter wavelength behind the centre pin. This added pin act as reflectors making the launcher directional.

In the above-described embodiments, surface wave launchers have been described. It will be appreciate that the aforementioned surface wave launchers may operate in reverse and act as surface wave collectors. In other words, a launcher of the present invention may either act to “launch” surface waves over a suitable surface, or to “collect” surface waves from a suitable surface.

In the above described embodiments, the first planar conductor is triangular. The width of the first planar conductor tapers from the launch end to the feed end. It will be appreciated that the first planar conductor may be take other triangular shapes, or shapes that are not triangular, while tapering from the launch end to the feed end.

In the above described embodiments, the axially orientated pins may be referred to as elements. These elements may be formed by other means, as will be appreciated by the person skilled in the art. For example, instead of conductive pins, air gaps could be formed in the waveguide.

Features of the present invention are defined in the appended claims. While particular combinations of features have been presented in the claims, it will be appreciated that other combinations, such as those provided above, may be used.

Further modifications and variations of the aforementioned systems and methods may be implemented within the scope of the appended claims.

1. A surface wave launcher for launching electromagnetic surface waves, the launcher comprising:
a waveguide having a feed end and a launch end;
a feed structure coupled to the feed end of the waveguide, wherein the feed structure includes a first conductor;
wherein the waveguide comprises a first planar conductive layer having the feed end and the launch end of the waveguide, the feed end being coupled to the first conductor;
wherein the waveguide is arranged to be positioned adjacent a surface suitable for guiding electromagnetic surface waves; and
wherein a width of the first planar conductive layer tapers from the launch end towards the feed end.

2. A surface wave launcher according to claim 1, wherein the first planar conductive layer is wider at the launch end than at the feed end.

3. A surface wave launcher according to claim 2, wherein the first planar conductive layer includes a first corner, the first planar conductive layer being coupled to the first conductor at the first corner.

4. A surface wave launcher according to claim 3, wherein the first planar conductive layer further includes a first edge, the first edge being at said launch end.

5. A surface wave launcher according to claim 4, wherein the first planar conductive layer is substantially triangular, the first corner being a corner of the triangle and the first edge being an edge of the triangle.

6. A surface wave launcher according to claim 1, wherein the feed structure has an axis.

7. A surface wave launcher according to claim 6, wherein the feed structure is a coaxial cable.

8. A surface wave launcher according to claim 7, wherein the first planar conductive layer is coupled to an inner conductor of the coaxial cable at the feed end of the waveguide.

9. A surface wave launcher according to claim 8, wherein a plane of the first planar conductive layer is aligned with the axis of the coaxial cable.

10. A surface wave launcher according to claim 8, wherein the coaxially cable includes a centre pin, coupled to the inner conductor, and coupled to the feed structure.

11. A surface wave launcher according to claim 1, wherein the waveguide further comprises a dielectric layer, the first planar conductive layer positioned on or adjacent a first surface of the dielectric layer.

12. A surface wave launcher according to claim 11, wherein the waveguide further comprises a second planar conductive layer positioned on or adjacent a second surface of the dielectric layer opposing the first surface.

13. A surface wave launcher according to claim 12, wherein the dielectric layer and the second planar conductive layer are substantially the same shape.

14. A surface wave launcher according to claim 13, wherein the dielectric layer and the second planar conductive layer are substantially the same width at the feed end as at the launch end of the waveguide.

15. A surface wave launcher according to claim 14, wherein the dielectric layer and second planar conductive layer are substantially rectangular.

16. A surface wave launcher for launching electromagnetic surface waves, the launcher comprising:
a waveguide having a feed end and a launch end;
a feed structure coupled to the feed end of the waveguide;
wherein the feed structure has a primary axis and includes a first conductor;
wherein the waveguide comprises a first planar conductive layer coupled to the first conductor and extending radially outward relative to the primary axis;
wherein the waveguide is arranged to be positioned adjacent a surface suitable for guiding electromagnetic surface waves; and
wherein the waveguide comprises one or more elements arranged to cause a signal generated by the waveguide to be emitted in a predetermined direction.

17. A surface wave launcher according to claim 16, wherein said one or more elements are axially orientated.

18. A surface wave launcher according to claim 16, wherein said one or more elements are pins.

19. A surface wave launcher according to claim 16, wherein the waveguide further comprises a dielectric layer, and the waveguide is oriented perpendicular to the primary axis.

20. A surface wave launcher according to claim 19, wherein the waveguide has a first surface proximal to the feed structure and a second surface distal to the feed structure; and the first planar conductive layer forms said first surface and the dielectric layer forms said second surface.

21. A surface wave launcher according to claim 20, wherein said feed structure is a coaxial cable having an inner conductor and an outer conductor.

22. A surface wave launcher according to claim 21, wherein the feed structure further comprises a coupling pin, and the waveguide includes a recess, the coupling pin arranged to fit within the recess.

23. A surface wave launcher according to claim 16, wherein the waveguide is substantially circular.
